(19) United States
(12) Patent Application Publication
(10) Pub. No.: US 2012/0292065 A1
(43) Pub. Date: Nov. 22, 2012

(54) Impact Tool

(75) Inventors: Tomoyuki Hoshi, Hitachinaka-shi (JP); Katsuhiro Oomori, Hitachinaka-shi (JP); Mizuho Nakamura, Hitachinaka-shi (JP)

(73) Assignee: HITACHI KOKI CO. LTD, Tokyo (JP)

(21) Appl. No.: 13/496,837

(22) PCT Filed: Feb. 2, 2011
(86) PCT No.: PCT/JP2011/052672

§ 371 Date: May 24, 2012

(30) Foreign Application Priority Data
Feb. 11, 2010 (JP) 2010-028313

(51) Int. Cl. B25B 21/02

(52) U.S. Cl. 173/93

(57) ABSTRACT

An impact tool includes a motor, a housing, a hummer, an anvil, a hummer case, and an end tool holding unit. The housing accommodates therein the motor. The hummer is rotatable by the motor. The hummer strikes against the anvil in a rotational direction of the hummer. The hummer case covers the hummer and the anvil. The end tool holding unit is connected to the anvil and protrudes from the hummer case in a first direction. The housing supports the hummer case at at least two locations.

### TECHNICAL FIELD The present invention relates to an impact tool driven by a motor and implementing a new impact mechanism part.

### BACKGROUND ART

In an impact tool, a rotational impact mechanism is driven by a motor as a driving source, and rotates and strikes an anvil to transmit an intermittent rotational striking force to an end tool for tightening a screw. A brushless DC motor has been widely used as a motor. The brushless DC motor is, for example, a DC (direct current) motor without a brush (a rectifying brush), uses a coil provided in a stator and a magnet (permanent magnet) provided in a rotor, and electric power generated in an inverter circuit is applied to the coil in order to rotate the rotor. The inverter circuit is configured of a large capacity output transistor such as an FET (field effect transistor) or an IGBT (insulated gate bipolar transistor), and is driven by a high current. The brushless DC motor has a desirable torque characteristics in comparison with a DC motor having brushes, and can tighten the screw, a bolt, or the like into a workpiece with a stronger force.

As an example of the impact tool using the brushless DC motor, a technique of Patent literature 1 is well known in the art. The conventional impact tool is provided with a continuously rotatable impact mechanism. Upon applying a rotational force from the motor to a spindle through a power transmission mechanism part (deceleration mechanism), a hammer supported movable in an axial direction of the spindle is rotated, and then an anvil rotates in abutment with the hammer. The hammer and the anvil respectively have two convex parts (striking parts) symmetrically located on a rotational plane. These convex parts are located so as to engage with each other in the rotational direction, thereby transmitting a rotational striking force from the hummer to the anvil. The hammer is slidable in the axial direction with respect to the spindle in a ring area surrounding the spindle. The hummer is formed with a hammer side cam groove having a reversed V-shaped (substantially triangular) on the inner circumference surface thereof, whereas the spindle is formed with a spindle side cam groove having V-shaped on the outer circumference surface thereof in the axial direction. The anvil is rotated through a ball (steel ball) inserted between the hammer side cam groove and the spindle side cam groove.

### CITATION LIST

### Patent Literature

PTL1: Japanese Patent Application Publication No. 2009-72888

### SUMMARY OF INVENTION

### Technical Problem

If an elongated end tool (bit) is used for tightening a screw into the workpiece such as wood, the anvil receives a reactive force from the screw through the end tool, which may cause a hammer case holding the anvil to be inclined with respect to a housing.

If the end tool is eccentric with respect to the rotational center of the anvil, the anvil receives the reactive force through the end tool, which may cause the hammer case to be inclined with respect to the housing.

The anvil receives the reactive force from the end tool so that the hammer case receives the reactive force through the anvil, which therefore causes misalignment of the hammer case with respect to the housing. Thus, the hammer may not effectively strike the anvil, and grease contained inside the hammer case may also leak out therefrom.

Additionally, the anvil eccentrically rotates with respect to the hammer case so that the hammer case is inclined with respect to the housing. As a result, a frictional force between the anvil and the hammer case increases, efficiency of the rotation is reduced, and pinching or gouging is generated therebetween.

It is an object of the present invention to prevent the hammer from misalignment with respect to the anvil, prevent the hammer from misalignment with the hammer case covering the hammer, and prevent grease contained inside the hammer case from leaking out.

### Solution To Problem

This objects of the present invention will be attained by an impact tool. The impact tool includes a motor, a housing, a hummer, an anvil, a hummer case, and an end tool holding unit. The housing accommodates therein the motor. The hummer is rotatable by the motor. The hummer strikes against the anvil in a rotational direction of the hummer. The hummer case covers the hummer and the anvil. The end tool holding unit is connected to the anvil and protrudes from the hummer case in a first direction. The housing supports the hummer case at at least two locations.

According to another aspect of the present invention, the present invention provides an impact tool. The impact tool includes a motor, a housing, a hummer, an anvil, a hummer case, and an end tool holding unit. The housing accommodates therein the motor. The hummer is rotatable by the motor. The hummer strikes against the anvil in a rotational direction of the hummer. The hummer case covers the hummer and the anvil. The hammer case has a front end portion. The end tool holding unit is connected to the anvil and protruding from the hummer case. The housing substantially covers an entirety of the hummer case including almost a major portion of the front end portion.

### Advantageous Effects

With this structure, since the hummer case is supported by the housing at least two locations, the hummer case is prevented from being misalignment with respect to the housing in the impact tool. Thus, the hummer efficiently strikes the anvil, pinching or gouging can be reduced, and leakage of grease can be prevented.

With this configuration, since the hummer case is fixed at both upper and lower sides thereof by a screw, the hummer case is prevented from being misalignment with respect to the housing in the impact tool. Thus, the pinching or gouging can be decreased, and the grease leakage can be prevented.

With this configuration, since the housing covers the hummer case by a front portion thereof, the hummer case is prevented from damaging to the workpiece such as wood. Thus, the hummer efficiently strikes the anvil, the pinching or gouging can be reduced, and the grease is prevented from leaking out.

### BRIEF DESCRIPTION OF DRAWINGS

In the drawings:

FIG. 1 is a cross-sectional view showing an overall structure of an impact tool according to a first embodiment of the present invention;

FIG. 2 is a perspective view showing an exterior appearance of the impact tool according to the first embodiment;

FIG. 3 is an enlarged cross-sectional view particularly showing a impact mechanism in the impact tool according to the first embodiment;

FIG. 4 is a perspective view of a cooling fan in the impact tool according to the first embodiment;

FIG. 5 is a block diagram illustrating a drive control system for driving a motor of the impact tool according to the first embodiment;

FIG. 6 is a perspective view showing a hammer and an anvil in an impact tool according to a basic configuration of the present invention;

FIG. 7 (a) is an explanatory diagram illustrating a strike operation between the hammer and the anvil according to the basic configuration of the present invention;

FIG. 7(b) is an explanatory diagram illustrating the strike operation when the hammer rotates in a clockwise direction from FIG. 7(a);

FIG. 7(c) is an explanatory diagram illustrating the strike operation when the hammer is positioned at a stop position;

FIG. 7(d) is an explanatory diagram illustrating the strike operation when the hammer rotates in a counterclockwise direction from FIG. 7(c);

FIG. 7(e) is an explanatory diagram illustrating the strike operation when the hammer strikes the anvil;

FIG. 7(f) is an explanatory diagram illustrating the strike operation when the anvil rotates together with the hammer;

FIG. 8 is a perspective view showing the hammer as viewed from diagonally front and the anvil as viewed from diagonally rear in the impact tool according to the first embodiment;

FIG. 9 is a perspective view showing the hammer as viewed from diagonally rear and the anvil as viewed from diagonally front in the impact tool according to the first embodiment;

FIG. 10(a) is an explanatory diagram illustrating a strike operation between the hammer and the anvil taken along a line X-X in FIG. 3 in the impact tool according to the first embodiment;

FIG. 10(b) is an explanatory diagram illustrating the strike operation when the hammer rotates in a counterclockwise direction from FIG. 10(a);

FIG. 10(c) is an explanatory diagram illustrating the strike operation when the hammer strikes the anvil;

FIG. 10(d) is an explanatory diagram illustrating the strike operation when the anvil rotates together with the hammer;

FIG. 11 is a diagram illustrating a trigger signal, a drive signal of an inverter circuit, a rotational speed of the motor, and a detection result of a strike between the hammer and the anvil in the impact tool according to the first embodiment;

FIG. 12 is a flowchart illustrating a procedure for controlling the impact tool according to the first embodiment;

FIG. 13 is a graph illustrating a relationship between number of rotations of the motor and elapsed time and a relationship between a current value and elapsed time in the impact tool according to the first embodiment;

FIG. 14 is a flowchart illustrating a procedure for controlling the impact tool in a pulse mode (1) according to the first embodiment;

FIG. 15 is a graph showing a relationship between number of rotations of the motor and elapsed time and a relationship between the current value and elapsed time in the impact tool according to the first embodiment;

FIG. 16 is a flowchart illustrating a procedure for controlling the impact tool in a pulse mode (2) according to the first embodiment; and

FIG. 17 is an enlarged view particularly showing an impact mechanism in an impact tool according to a second embodiment of the present invention.

### DESCRIPTION OF EMBODIMENTS

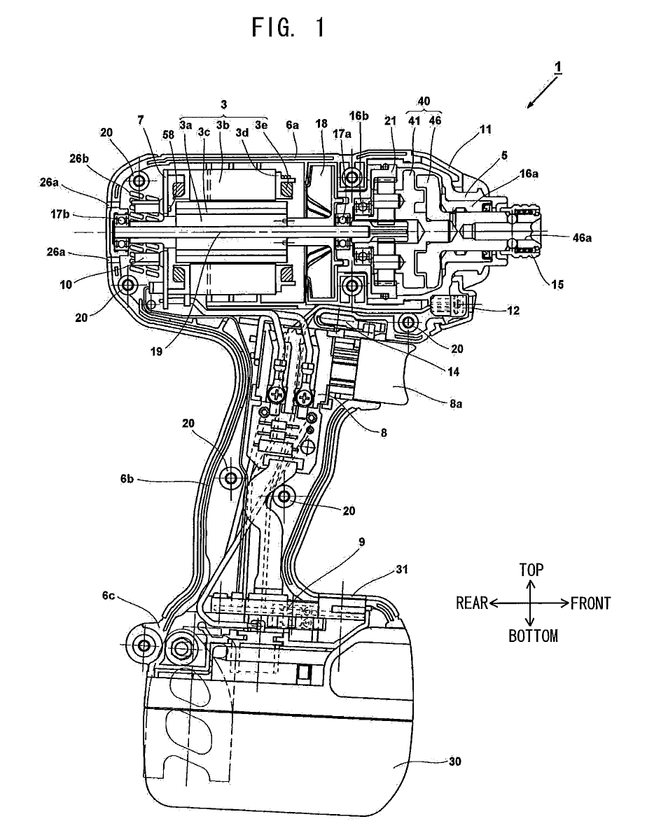

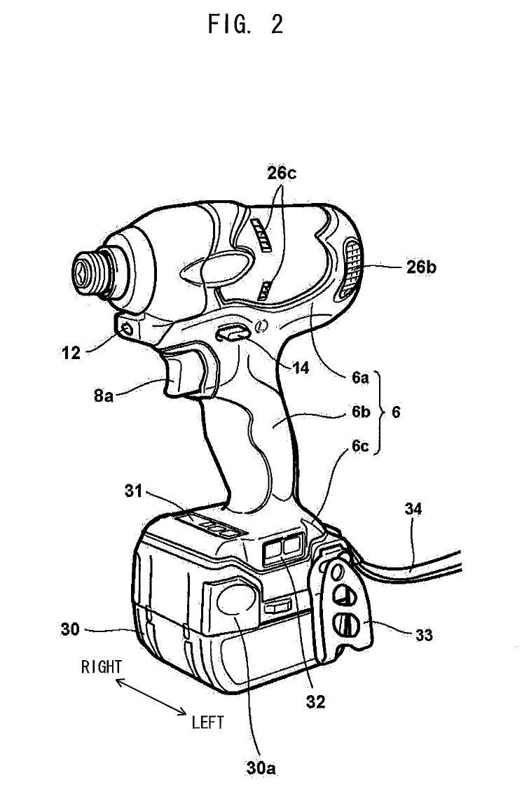

An impact tool according to a first embodiment of the present invention will be described with reference to the accompanying drawings. Meanwhile, in the following description, the upper-lower, front-rear, and the right-left directions are defined as respective directions shown in FIGS. 1 and 2.

An impact tool 1 includes a housing 6, a motor 3 accommodated in the housing 6, an impact mechanism 40, a planetary gear deceleration mechanism 21, a hummer case 5 for accommodating the impact mechanism 40 and the planetary gear deceleration mechanism 21, and a rechargeable battery pack 30 (FIG. 1). By rotating the motor 3, a continuous rotational force or an intermittent striking force is transmitted to an end tool (not shown) such as a driver bit for tightening a screw or a bolt through the impact mechanism 40. The housing 6 includes a cylindrical trunk part 6a extending in front-to-rear direction, a grip part 6b extending from and substantially orthogonally to the trunk part 6a, and a battery holder 6c provided below the grip part 6b for detachably holding the battery pack 30.

The motor 3 is a brushless DC motor and is accommodated in the trunk part 6a as viewed from the lateral side. The motor 3 has a rotation shaft 19, a rotor 3a fixed on the rotation shaft 19, a stator 3b having a coil 3e, and an insulator 3d. The rotation shaft 19 is rotatably supported by a bearing 17b at the rear end portion of the trunk part 6a and a bearing 17a located substantially center portion of the trunk part 6a. The detail construction of the motor 3 will be described later.

The housing 6 is dividable into two housing parts having almost symmetrical shapes in a right-to-left direction. As shown in FIG. 1, one of the divided housing parts (the left side housing) has a plurality of screw bosses 20, and the other housing part (the right side housing) has a plurality of screw holes (not shown). The two housings are fixed with each other by a plurality of screws extending through the screw bosses 20 and threadingly engaged with the screw holes.

The trunk part 6a has a rear portion provided with a substrate (circuit board) 7 positioned behind the motor 3. The substrate 7 has a rear surface provided with six switching elements 10, and a front surface provided with a rotational position detecting element 58. The switching element 10 is adapted to perform an inverter control to rotate the motor 3. The rotational position detecting element 58, i.e., a Hall element and a Hall IC, is adapted to detect a rotational position of the rotor 3a.

The grip part 6b has an upper portion provided with a trigger 8 and a forward-reverse switching lever 14. The trigger 8 is provided with a trigger operating part 8a urged by a spring (not shown) so as to project from the grip part 6b. The grip part 6b has a lower portion provided with a control circuit substrate 9 which controls a speed of the motor 3 in accordance with an operation amount (stroke) of the trigger operating part 8a.

The battery pack 30 contains a plurality of battery cells such as nickel hydride cells and a lithium ion cells.

A cooling fan 18 is provided at the front portion of the motor 3 and is coaxially fixed to the rotation shaft 19, thereby rotating together with the motor 3. The cooling fan 18 sucks a cooling air from an air inlet 26a (FIG. 1), 26b (FIG. 2) formed in the rear portion of the trunk part 6a. The sucked cooling air is discharged to the outside of the housing 6 through a slits 26c (FIG. 2) formed in the trunk part 6a at a position radially outward of the cooling fan 18.

As shown in FIG. 4, the cooling fan 18 is an integral product made from a plastic material such as synthetic resin. The cooling fan 18 has a center portion formed with a penetrating hole 18a into which the rotation shaft 19 is fitted and provided with a cylindrical part 18b for covering the rotation shaft 19 in the axial direction by a predetermined distance and for ensuring the predetermined distance from the rotor 3a. A plurality of fins 18c is provided at the outer circumference side from the cylindrical part 18b and a circular annular part is formed at each axially one side and another side of the plurality of fins 18c. Cooling air is sucked from the rear side of the cooling fan 18 in the axial direction and is discharged from a plurality of openings 18d formed in the outer circumference of the cooling fan 18 to the outside in the radial direction. The cooling fan 18 functions as a so-called centrifugal fan. Since the cooling fan 18 is not connected to the planetary gear deceleration mechanism 21 but directly connected to the rotation shaft 19, the cooling fan 18 rotates at the sufficiently large number of rotations in comparison with that of a hammer 41, thereby ensuring sufficient air flow volume.

The impact mechanism 40 includes the hammer 41 and an anvil 46. The hammer 41 supports rotation shafts 21c of a plurality of planetary gears of the planetary gear deceleration mechanism 21. The anvil 46 is positioned at the front side of the hummer 41 shown in FIG. 1. Unlike well-known impact mechanisms used currently widely, the hammer 41 does not have a cam mechanism including, for example, a spindle, a spring, a cam groove, and a ball. The end tool (not shown) is detachably mounted in the anvil 46. Specifically, the avail 46 has a front end portion formed with a hexagonal mounting hole 46a and provided with a sleeve 15 for attaching/detaching the end tool.

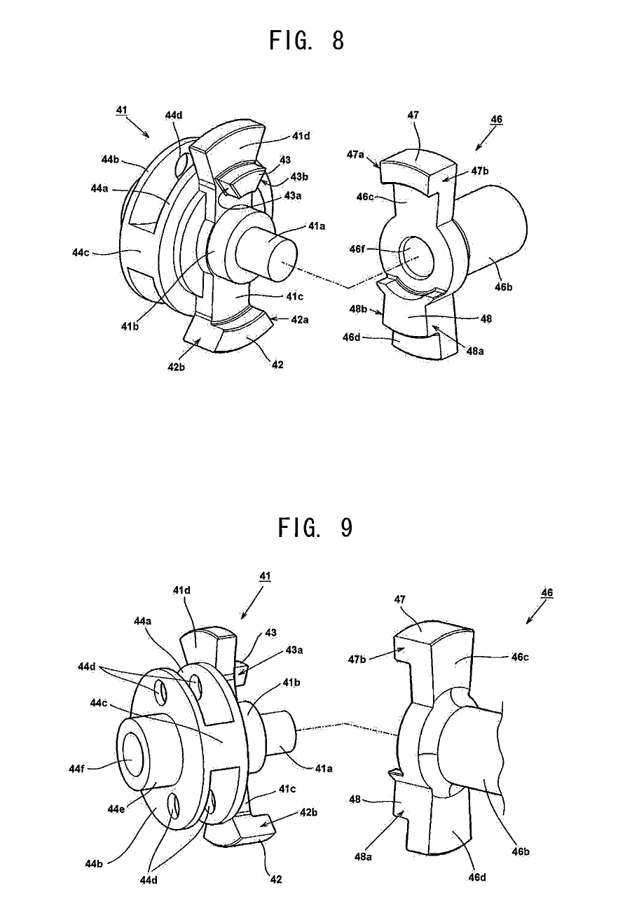

The hammer 41 and the anvil 46 are linked by a fitting shaft 41a of the hummer 41 and a fitting hole 46f of the anvil 46. The fitting hole 46f is positioned at a rotational center of the anvil 46. (FIGS. 8 and 9). The anvil 46 has a rear side portion linked to the fitting shaft 41a and is rotatably supported by the hummer case 5 via a metal bearing 16a at the center portion of the hummer case 5.

The hummer case 5 is formed by an integral metal molding and is located at the front side of the housing 6 for accommodating therein the impact mechanism 40 and the planetary gear mechanism 21. The hummer case 5 has an outer circumference surface covered with a resinous cover 11 provided at the front side of the trunk part 6a in order to prevent heat transfer and to absorb impacting force. Specifically, the hummer case 5 is supported by the trunk part 6a and the cover 11 so as not to move relative to the trunk part 6a and the cover 11.

When the trigger operating part 8a is pulled to start up the motor 3, the rotation of the motor 3 is decelerated by the planetary gear deceleration mechanism 21, and the hammer 41 rotates at the number of rotations having a predetermined deceleration ratio with respect to the number of rotations of the motor 3. Upon rotating the hummer 41, the rotational force is transmitted to the anvil 46, and then the anvil 46 starts to rotate at the same speed as the hammer 41. The anvil 46 receives a reactive force from the end tool to rotate in the circumferential direction. When the reactive force becomes larger, a computing part 51 (described later) detects the increase of the reactive force and drives the hammer 41 continuously or intermittently by changing a drive mode for the hammer 41 before the rotation of the motor 3 is stopped to be a locked state.

Additionally, a control panel 31 is provided on the upper surface of the battery holder 6c. The control panel 31 includes various manual operation buttons, indicator lamps, a switch for turning on/off an LED light 12, and a button for checking a remaining charged level of the battery pack 30. Additionally, as shown in FIG. 2, a toggle switch 32 for switching a drive mode (drill mode and impact mode) is provided on the lateral surface of the battery holder 6c. Each time the toggle switch 32 is pushed, the drill mode and the impact mode are alternately switched. The motor 3 continuously rotates in only a forward direction in the drill mode, whereas the motor 3 intermittently rotates in the forward and reverse direction in the impact mode.

As shown in FIG. 2, the battery pack 30 is provided with release buttons 30a positioned on both the right and left sides of the battery pack 30. The battery pack 30 is shifted to the front while pushing the release buttons 30a, which can remove the battery pack 30 from the battery holder 6c. A metal belt hook 33 is detachably provided on the right or left sides of the battery holder 6c. In FIG. 2, the belt hook 33 is attached on the left side of the impact tool 1. However, the hook 33 can also be detached from the left side and be attached on the right side. A strap 34 is attached at the rear end of the battery holder 6c.

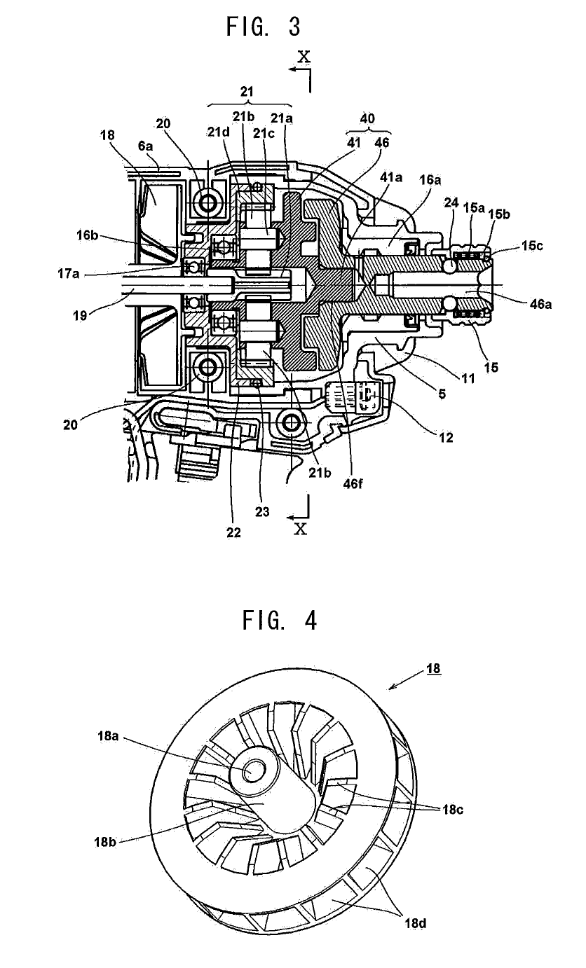

As shown in FIG. 3, in the planetary gear deceleration mechanism 21, a sun gear 21a is connected to the tip end of the rotation shaft 19 and functions as a drive shaft (input shaft), and a plurality of planetary gears 21b rotate inside an outer gear 21d fixed to the trunk part 6a. Each planetary gear 21b has a rotation shaft 21c held by the hammer 41 functioning as a carrier. The hammer 41 rotates in the same direction as the motor 3 at a predetermined reduction ratio and functions as a driven shaft (output shaft) of the planetary gear deceleration mechanism 21. The reduction ratio is determined based on a main tightened targets (a screw, a bolt, or other fasteners), an output of the motor 3, or the necessary tightening torque. In the first embodiment, the reduction ratio is set such that the number of rotations of the hammer 41 is in the range of one-eighth to one-fifteenth of the number of rotations of the motor 3.

An inner cover 22 is provided inside the trunk part 6a at radially inner side of two screw bosses 20. The inner cover 22 is an integrally molding product made from a plastic material such as synthetic resin. The inner cover 22 has a rear cylindrical part supporting the bearing 17a rotatably supporting the rotation shaft 19 and two cylindrical step parts having diameters different from each other at the front side of the inner cover 22. The smaller diameter part is provided with a bearing 16b for rotatably supporting the hummer 41, and the large diameter part supports a part of the outer gear 21d inserted from the front side. Meanwhile, since the outer gear 21d is attached to the inner cover 22 so as not to be rotatable, and since the inner cover 22 is attached to the trunk part 6a of the housing 6 so as not to be rotatable, the outer gear 21d is fixed so as not to be rotatable. Additionally, the outer gear 21d has an outer circumference part provided with a flange having a large outer diameter. An O-ring 23 is provided between the flange and the inner cover 22. A grease (not shown) is applied ambient to the hammer 41 and the anvil 46. The O-ring 23 is configured to prevent the grease from leaking to the inner cover 22 side.

In the first embodiment, the hammer 41 functions as a carrier holding the plurality of rotation shafts 21c of the planetary gears 21b. Therefore, the rear end of the hammer 41 extends to the inner circumference of the bearing 16b. Additionally, the hummer 41 is formed with a cylindrical internal space into which the sun gear 21a attached to the rotation shaft 19 is inserted. The fitting shaft 41a is provided at the substantially rotational center at the front side of the hammer 41 and projects to the front in the axial direction (FIGS. 8 and 9). The fitting shaft 41a fits into the cylindrical fitting hole 46f formed substantially in the rotational axis at the rear side of the anvil 46. The fitting shaft 41a is inserted into the fitting hole 46f to be rotatable relative to each other.

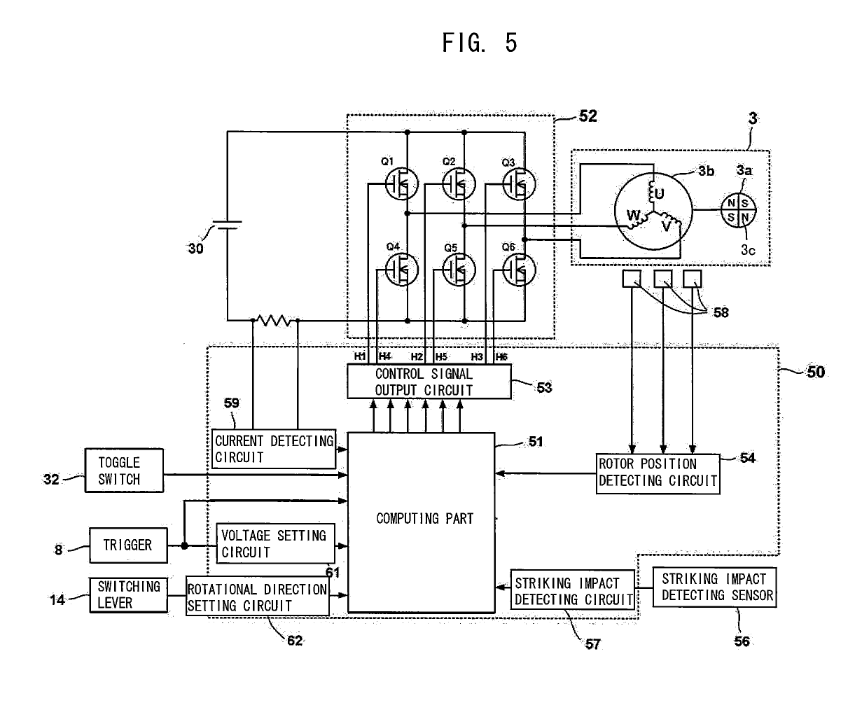

Next, a configuration and operations of a drive control system for the motor 3 will be described with reference to FIG. 5. In the first embodiment, the motor 3 is an inner rotor type three-phase brushless DC motor and includes the rotor 3a configured of two sets of permanent magnets 3c each having a north pole and a south pole, the stator 3b in which the coil 3e has star-wired three-phase stator windings U, V, and W, and the rotational position detecting elements (Hall element) 58 located at predetermined intervals, e.g., three elements located at intervals of an angle of 60 degrees in the circumferential direction. The computing part 51 described later controls a direction and time for applying current to the stator windings U, V, and W to rotate the motor 3 on the basis of a position detecting signal from these rotational position detecting elements 58. The rotational position detecting element 58 is provided on the substrate 7 at a position facing the permanent magnet 3c of the rotor 3a (FIG. 1).

Six switching elements Q1 to Q6 (corresponding to reference numeral 10 in FIG. 1) such as FETs connected in a three-phase bridge manner are provided on the substrate 7. Six bridge-connected switching elements Q1 to Q6 have their respective gates connected to a control signal output circuit 53 mounted on the control circuit substrate 9. Six switching elements Q1 to Q6 have their respective drains or sources connected to the star-wired stator windings U, V, and W. Thus, six switching elements Q1 to Q6 perform switching operations by switching-element drive signals (drive signals such as H4, H5, and H6) inputted from the control signal output circuit 53, and convert a direct voltage of the battery pack 30 applied to an inverter circuit 52 into three-phase (U-phase, V-phase, and W-phase) voltages Vu, Vv, and Vw to supply electric power to the stator windings U, V, and W, respectively.

Among six switching elements Q1 to Q6, pulse-width modulation signals (PWM signals) H4, H5, and H6 are supplied to negative supply voltage sides of three switching elements Q4, Q5, and Q6, respectively, as the switching-element drive signals (three-phase signals) driving the respective gates. The control circuit substrate 9 has the computing part 51 mounted thereon. The computing part 51 changes the pulse width (duty ratio) of the PWM signals on the basis of a detecting signal corresponding to an operation amount (stroke) of the trigger operating part 8a to adjust the amount of electric power supplied to the motor 3, thereby controlling start/stop and a rotational speed of the motor 3.

Now, the PWM signals are supplied to either the switching elements Q1 to Q3 at a positive supply voltage side or the switching elements Q4 to Q6 at the negative supply voltage side in the inverter circuit 52, which enables the switching elements Q1 to Q3 or Q4 to Q6 to perform high-speed switching to control electric power supplied from the battery pack 30 to the respective stator windings U, V, and W. In the first embodiment, since the PWM signals are supplied to the switching elements Q4 to Q6 at the negative supply voltage side, the pulse width of the PWM signals is controlled to adjust the electric power supplied to the respective stator windings U, V, and W, which can control the rotational speed of the motor 3.

The impact tool 1 is provided with the switching lever 14 for switching the rotational direction of the motor 3. A rotational direction setting circuit 62 switches the rotational direction of the motor 3 each time detecting a change in the switching lever 14, and transmits a control signal to the computing part 51. The computing part 51 includes a central processing unit (CPU) for outputting the drive signal on the basis of a processing program and data, a ROM for storing the processing program or control data, a RAM for temporarily storing the data, and a timer, or the like (not shown).

The computing part 51 generates drive signals for properly alternately switching the switching elements Q1 to Q6 on the basis of the output signals from the rotational direction setting circuit 62 and from a rotor position detecting circuit 54, and outputs the drive signals to the control signal output circuit 53. Thus, a current is properly alternately applied to the stator windings U, V, and W to rotate the rotor 3a in the prescribed rotational direction. In this case, the drive signals applied to the switching elements Q4 to Q6 at the negative supply voltage side are outputted as PWM modulation signals on the basis of an output control signal from a voltage setting circuit 61. A current detecting circuit 59 measures a current value supplied to the motor 3 and transmits the current value to the computing part 51 to thereby adjust the current value to the preset electric power. The PWM signals may be applied to the switching elements Q1 to Q3 at the positive supply voltage side.

A controller 50 is mounted on the control circuit substrate 9 and, a striking impact detecting sensor 56 is connected to the controller 50 for detecting the magnitude of impact caused at the anvil 46. This detection results is inputted through a striking impact detecting circuit 57 to the computing part 51. The striking impact detecting sensor 56 is, for example, a strain gauge attached to the anvil 46. The output of the striking impact detecting sensor 56 may be used to automatically stop the motor 3 when the tightening is finished at a prescribed torque.

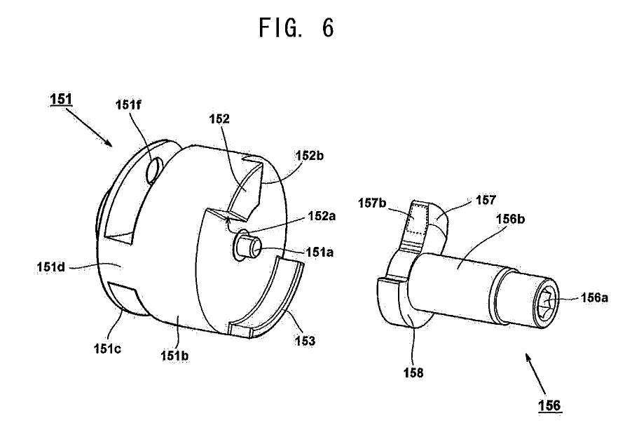

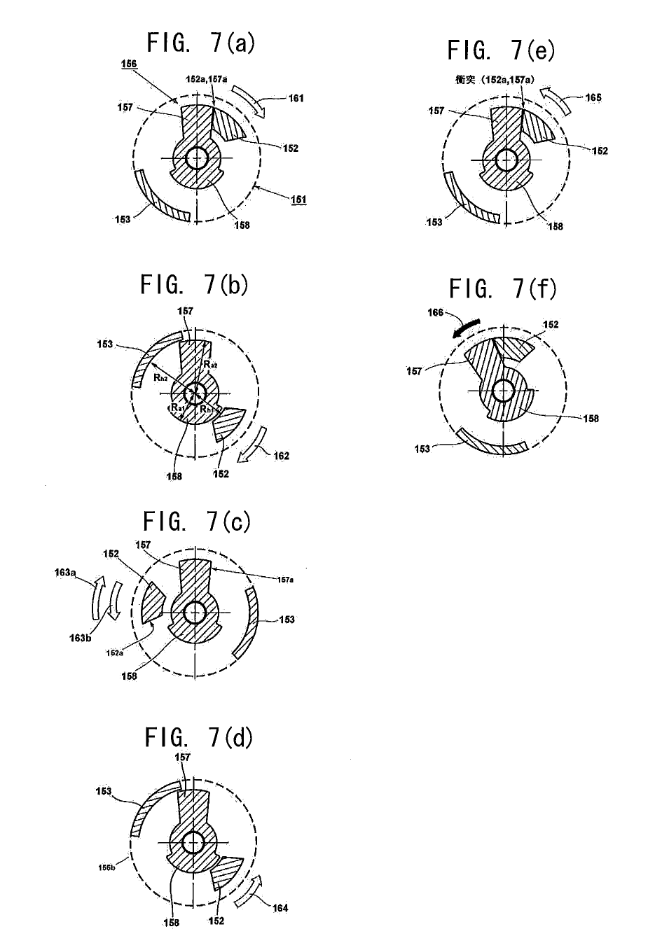

Next, a fundamental concept in terms of a structure of the hammer 41 and the anvil 46 of the present invention and the principle of a striking operation therebetween will be described with reference to FIGS. 6 and 7. FIG. 6 shows shapes of a hammer 151 and an anvil 156 in accordance with the fundamental concept of the present invention. The hammer 151 includes a cylindrical main body 151b, one set of projecting parts, i.e., a projecting part 152 and a projecting part 153, projecting in the axial direction from the cylindrical main body 151b, a fitting shaft 151a formed at the center on the front side of the main body 151b, a disk part 151c provided at the rear side of the main body 151b, and a connection part 151d connecting the main body 151b to the disk part 151c. The fitting shaft 151a fits into a fitting hole (not shown) formed at the rear face of the anvil 156 so that the hammer 151 links with the anvil 156 so as to be rotatable relative to each other by a predetermined angle less than one relative rotation (less than 360 degrees). The projecting part 152 has planar striking surfaces 152a, 152b formed on both sides thereof in the circumferential direction. Additionally, the projecting part 153 is adapted for redressing the rotational balance with the projecting part 152. Since the projecting part 153 functions as a balancing weight part for redressing the rotational balance, a striking surface is unnecessary in the projecting part 153.

A space is provided between the main body 151b and the disk part 151c to locate the planetary gears 21b of the planetary gear deceleration mechanism 21. Penetrating holes 151f are formed in the disc part 151c for holding the rotation shafts 21c of the planetary gears 21b. Although not shown in the drawing, holding holes are also formed for holding the rotation shafts 21c of the planetary gears 21b in the rear surface facing the disk part 151c of the main body 151b.

The anvil 156 includes a cylindrical main body 156b in which a mounting hole 156a for mounting the end tool is formed in the front end portion, and two projecting parts 157 and 158 formed at the rear side of the main body 156b and projecting radially outwardly from the main body 156b. The projecting part 157 functions as the striking part having struck surfaces 157a (FIG. 7(e)) and 157b. The projecting part 158 is a balancer weight part and a struck surface is not required therein. The projecting part 157 is configured to collide with the projecting part 152, and therefore, the projecting part 157 has an outer diameter the same as that of the projecting part 152. In contrast, both the projecting parts 153 and 158 are merely operated as the weight part and are not to collide with any parts. Therefore, the projecting parts 153 and 158 have such a shape and are located at such a position that these parts do not interfere with each other. Additionally, in order to acquire relative rotational angle as large as possible between the hammer 151 and the anvil 156 (yet less than one rotation at most), the projecting parts 153 and 158 have reduced thickness or length in the radial direction and increased length in the circumferential direction so as to redress the rotational balance between the projecting parts 152 and 157. Increased relative rotational angle can prolong an acceleration interval (run-up interval) for the hammer 151 running toward the anvil 156. Thus the increased relative rotational angle can generate higher kinetic energy.

FIG. 7 is a cross-sectional view illustrating six rotational phases of the hammer 151 and the anvil 156 during a single operation stroke. The cross-sectional surface is a plane orthogonal to the axial direction and includes the striking surface 152a (FIG. 6). When the reactive force received from the end tool is small, the anvil 156 is rotated in the counterclockwise direction by being pushed by the hammer 151. If the reactive force is increased, the anvil 156 cannot be rotated by only the pushing force from the hammer 151. In order to strike the hammer 151 to the anvil 156, as shown in FIG. 7(a), the motor 3 starts to reversely rotate to make the projecting part 152 of the hummer 151 reversely rotate in the direction of an arrow 161.

As shown in FIG. 7(b), the motor 3 reversely rotates so that the projecting part 152 is accelerated in the direction of an arrow 162 passing through the outer circumference of the projecting part 158. The projecting part 158 has an outer diameter Rₐ₁ smaller than an inner diameter Rₕ₁ of the projecting part 152, and thus both the projecting parts 158 and 152 do not collide with each other, whereas the projecting part 157 has an outer diameter Rₐ₂ smaller than an inner diameter Rₕ₂ of the projecting part 153, and thus both the projecting parts 157 and 153 do not collide with each other. With this positional and dimensional relationship, the relative rotational angle between the hammer 151 and the anvil 156 greater than 180 degrees can be acquired, and a sufficient reverse rotational angle of the hammer 151 can be ensured with respect to the anvil 156.

When the hammer 151 is further reversely rotated to arrive at a position (a stop position for the reverse rotation) in FIG. 7(c) as indicated by an arrow 163a (reverse direction), the motor 3 stops rotating for a certain period, and then starts to rotate in the direction of an arrow 163b (forward direction). When the hammer 151 is reversely rotated, the hammer 151 should be surely stopped at the stop position so as to avoid the hammer 151 colliding with the anvil 156. Although the distance between the hammer 151 and the anvil 156 can arbitrarily be set to define the stop position, the distance is set preferably as long as possible based on the necessary tightening torque. Additionally, the stop position does not need to be set at a constant position every time. For example, the stop position can be set to have a smaller reverse rotation angle in an initial phase of the tightening and can be set to have a greater reverse rotational angle as the tightening proceeds. In this way, the stop position is variable so that a time period required for the reverse rotation of the hummer 151 can be minimized, thereby rapidly performing the striking operation for a short period.

Then, the hammer 151 is rotated in the counterclockwise direction as shown in FIG. 7(d) in the direction of an arrow 164. While the hammer 151 is accelerated, the striking surface 152a of the projecting part 152 collides with the struck surface 157a of the anvil 156 at a position shown in FIG. 7(e). As a result of this collision, as shown in FIG. 7(f), strong rotational torque is transmitted to the anvil 156, which rotates the anvil 156 in the direction indicated by an arrow 166. In this state, both the hammer 151 and the anvil 156 are rotated by a predetermined angle from a state shown in FIG. 7(a). The operations from FIG. 7(a) to FIG. 7(f) are repeatedly performed to tighten the tightened targets at a proper torque.

As described above, the present invention employs the drive mode in which the motor 3 reversely rotates, whereby the impact tool 1 is realized with a simple configuration only including the hummer 151 and the anvil 156 as the impact mechanism. The drive mode of the motor 3 can be set to a drill mode in the impact mechanism. For example, in the drill mode, the motor 3 is rotated from a state shown in FIG. 7(e) to rotate the hammer 151 in the forward direction, which enable the anvil 156 to follow and rotate as shown in FIG. 7(f). With this configuration, rapid tightening can be performed for tightening the targets such as the screw and the bolt those not requiring high torque.

Furthermore, in the impact tool 1 in the first embodiment, since the brushless DC motor is employed, an electronic clutch mechanism can be realized by acquiring the current value of the motor 3 from the current detecting circuit 59, detecting a prescribed state in which the current value exceeds a prescribed value, halting the motor 3 by the computing part 51, and thereby blocking the drive transmission after tightening at a predetermined torque. Therefore, in the impact tool 1 of the present invention, the clutch mechanism can be realized in the drill mode, and a multi-use tightening tool having the drill mode without/with a clutch and the impact mode can be realized by the simply configured impact mechanism.

Next, a detailed structure of the impact mechanism 40 according to the first embodiment will be described. The hammer 41 is provided with two wing parts 41c and 41d which project from a columnar main body 41b in the radial direction. The wing parts 41c and 41d respectively have projecting parts 42 and 43 projecting in the axial direction. The hammer 41 and the anvil 46 of the first embodiment is different from that of the basic configuration shown in FIG. 6 in that one set of a striking part and a weight part is formed in each of the wing parts 41d and 41c.

The wing part 41c has a sector shape, and the projecting part 42 projects from the outer circumference part of the wing part 41c to the front in the axial direction. The projecting part 42 also has a sector shape and has a function as the weight part and as the striking part. The projecting part 42 has striking surfaces 42a and 42b on both sides in the circumferential direction. The striking surfaces 42a and 42b are formed in the shape of a plane and slants with respect to the radial direction so as to be properly contacted with struck surfaces 47a and 47b of the anvil 46 described later.

The wing part 41d also has a sector shape. The wing part 41d properly functions as the weight part because of the sector shape in which a size of a radially outer portion thereof is greater than that of the radially inner portion thereof. The projecting part 43 is provided at the substantially intermediate portion of the wing part 41d in the radial direction and projects to the front in the axial direction. The projecting part 43 functions as the striking part and has striking surfaces 43a and 43b formed on both sides in the circumferential direction. The striking surfaces 43a and 43b are formed in the shape of a plane and slants with respect to the radial direction so as to be properly contacted with struck surfaces 48a and 48b of the anvil 46 described later.

The fitting shaft 41a is formed at a center of the main body 41b and is adapted to fit into the fitting hole 46f of the anvil 46. The hummer 41 further has two disk parts 44a and 44b at the rear side of the main body 41b functioning as a carrier, and has connection parts 44c connecting these disk parts 44a and 44b together at two positions spaced away from each other in the circumferential direction. As shown in FIG. 9, penetrating holes 44d are formed at two positions spaced away from each other in the circumferential direction of each of the disk parts 44a and 44b. Two planetary gears 21b (FIG. 3) are located between the disk parts 44a and 44b, and the rotation shafts 21c (FIG. 3) of the planetary gears 21b are fitted into the penetrating holes 44d. A cylindrical part 44e is formed at the rear side of the disk part 44b (FIG. 9) and cylindrically extends in the axial direction. The cylindrical part 44e has the outer circumference held by the inner surface of the bearing 16b shown in FIG. 3. Additionally, the sun gear 21a (FIG. 3) is inserted into a space 44f formed inside the cylindrical part 44e. Meanwhile, the hammer 41 and the anvil 46 shown in FIGS. 8 and 9 are preferably integral metal products from a viewpoint of mechanical strength and weight.

The anvil 46 is provided with two wing parts 46c and 46d projecting from a columnar main body 46b in the radial direction. A projecting part 47 is formed at the outer end portion of the wing part 46c and projects rearward in the axial direction. The struck surfaces 47a and 47b are formed on both sides in the circumferential direction of the projecting part 47. On the other hand, a projecting part 48 is formed at the substantially intermediate portion of the wing part 46d in the radial direction and projects rearward in the axial direction. The struck surfaces 48a and 48b are formed on both sides in the circumferential direction of the projecting part 48. When the hammer 41 rotates in the forward direction (rotational direction for tightening a screw), the striking surface 42a contacts the struck surface 47a while the striking surface 43a contacts the struck surface 48a. Additionally, when the hammer 41 rotates in the reverse direction (rotational direction of loosening a screw), the striking surface 42b contacts the struck surface 47b while the striking surface 43b contacts the struck surface 48b. The projecting parts 42, 43, 47, and 48 are formed so as to cause this contact at the same time.

In this way, the hammer 41 and the anvil 46 shown in FIGS. 8 and 9 strike at two symmetrical positions with respect to the rotating axis, which can therefore provide a favorable rotational balance and reduce a shaking of the impact tool 1 during the striking operation. Additionally, since the striking surfaces 42a, 42b, 43a, and 43b are formed on both the respective sides in the circumferential direction of the projecting part 42 and 43, the impact operation is enabled for not only the forward rotation but also the reverse rotation, which can therefore realize a user-friendly impact tool. Furthermore, since the hammer 41 strikes the anvil 46 not in the axial direction but in the circumferential direction, excessive tightening can be avoided, which is advantageous for tightening a wood-screw into a wood.

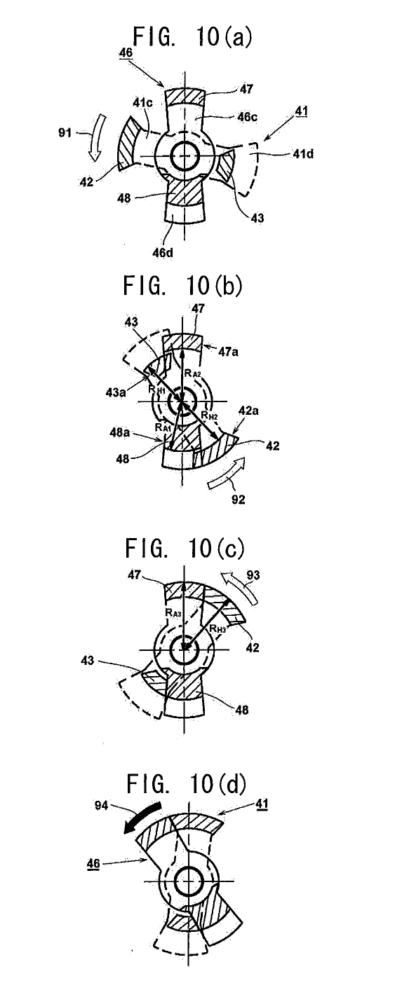

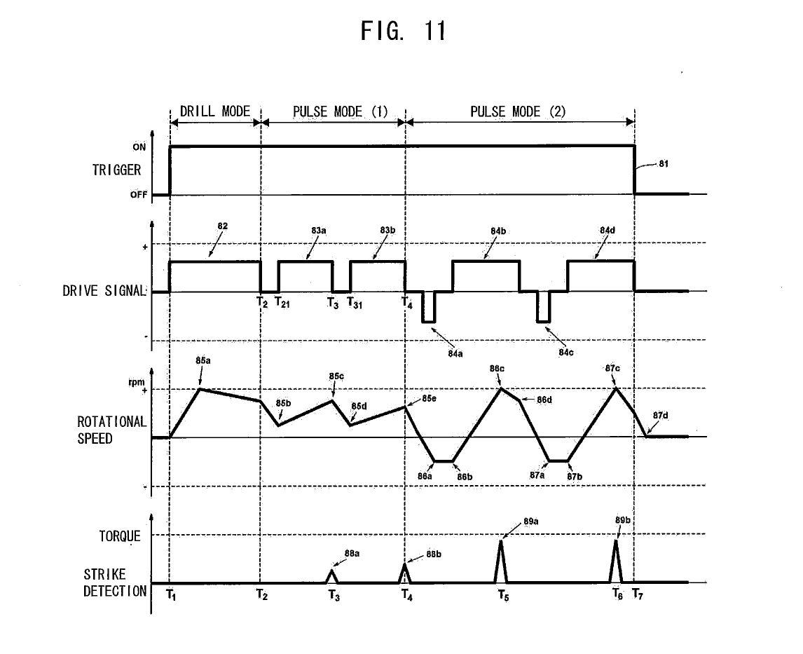

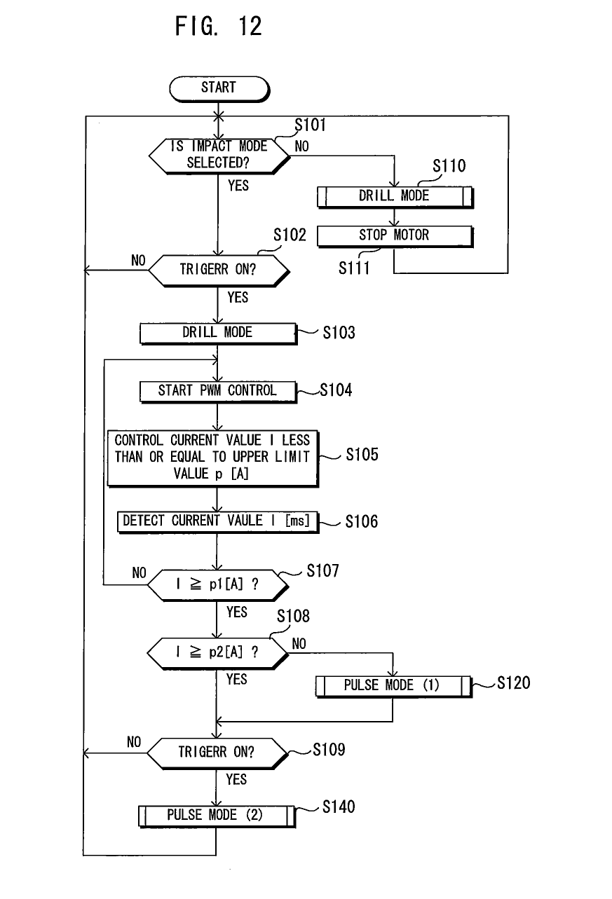

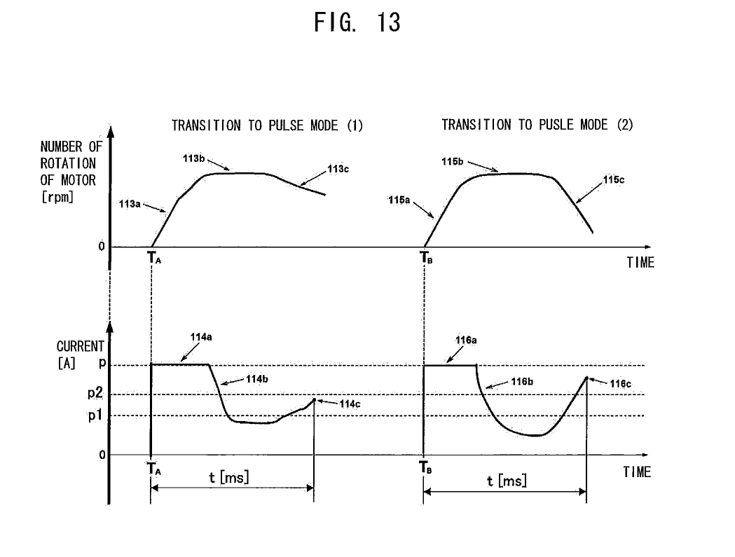

Next, the striking operation of the hammer 41 and the anvil 46 shown in FIGS. 8 and 9 will be described with reference to FIG. 10. The operation is basically the same as the operation described in FIGS. 7(a)-7(f), but is different in that the substantially axially symmetrical striking surfaces at two positions are struck at the same time instead of one position. Additionally, a cross-sectional view shown in FIG. 10 shows the positional relationship between the projecting parts 42, 43 projecting from the hammer 41 in the axial direction and the projecting parts 47, 48 projecting from the anvil 46 in the axial direction. During a tightening operation (when rotating forward), the anvil 47 rotates in the counterclockwise direction.

FIG. 10(a) shows such a state that the hammer 41 reversely rotates up to a maximum reverse rotational position (stop position) with respect to the anvil 46 (corresponding to a state in FIG. 7(c)). The hammer 41 is accelerated in the direction of an arrow 91 (forward direction) so as to collide with the anvil 46. Then, as shown in FIG. 10(b), the projecting part 42 passes through the outer circumference side of the projecting part 48, and the projecting part 43 passes through the inner circumference side of the projecting part 47 at the same time. In this way, in order to enable both the projecting parts 42 and 43 to pass through, the projecting part 42 has an inner diameter R_{H2} larger than an outer diameter R_{A1} of the projecting part 48, and thus the projecting parts 42 and 48 do not collide with each other. Similarly, the projecting part 43 has an outer diameter R_{H1} smaller than an inner diameter R_{A2} of the projecting part 47, and thus the projecting parts 43 and 47 do not collide with each other. With this configuration, the relative rotational angle between the hammer 41 and the anvil 46 can be greater than 180 degrees, so that a sufficient reverse rotational angle of the hammer 41 can be ensured with respect to the anvil 46, and this reverse rotational angle can function as an acceleration distance before the hammer 41 strikes the anvil 46.

Next, when the hammer 41 further forwardly rotates as shown in FIG. 10(c), the striking surface 42a of the projecting part 42 collides with the struck surface 47a of the projecting part 47. At the same time, the striking surface 43a of the projecting part 43 collides with the struck surface 48a of the projecting part 48. The hummer 41 and anvil 46 collides at two diametrically opposite positions with respect to the rotation shaft, thereby striking with a favorable rotational balance. As a result of this striking, as shown in FIG. 10(d), the anvil 46 is rotated in the direction of an arrow 94 thereby tightening the tightened target. Meanwhile, the hammer 41 has the projecting part 42 as only one prominence at a concentric position in the radial direction ranging from R_{H2} to R_{H3}, and the projecting part 43 as only one prominence at a concentric position (position equal to or less than R_{H1}). Additionally, the anvil 46 has the projecting part 47 as only one prominence at a concentric position in the radial direction ranging from R_{A2}, to R_{A3}, and the projecting part 48 as only one prominence at a concentric position (position equal to or less than R_{A1}).

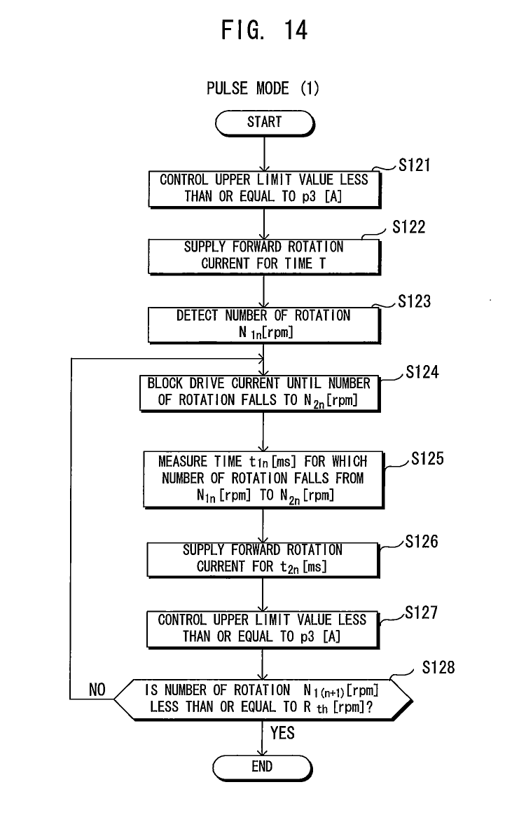

Next, a method for driving the impact tool 1 according to the first embodiment will be described with reference to FIG. 11. The anvil 46 and the hammer 41 are rotatable relative to each other at the relative rotational angle less than 360 degrees. The rotation of the hammer 41 is controlled as described below. Each graph of FIG. 11 has a horizontal axis representing time, and is drawn by aligning the horizontal axis so that timing of each graph can be compared. A trigger signal, a drive signal of the inverter circuit, a rotation speed of the motor 3, and impacting state between the hammer 41 and the anvil 46 are shown in relation to the time.

In the tightening operation at the impact mode, the impact mode includes three phase rotational drive modes. The tightening is first performed at high speed in a drill mode, and the drill mode is changed to a pulse mode (1) when the necessary tightening torque increases, and is finally changed to a pulse mode (2) when the necessary tightening torque further increases. In the drill mode from time T₁ to time T₂ in FIG. 11, the computing part 51 controls the motor 3 to rotate at a target number of rotations. Specifically, the motor 3 is accelerated until reaching the target number of rotations indicated by an arrow 85a. After that, when the reactive force from the end tool attached to the anvil 46 increases, the rotational speed of the motor 3 decreases gradually. Thus, when the decrease in the rotational speed is detected by the current value supplied to the motor 3 (current detecting circuit 59), the computing part 51 switches the rotational drive mode to the pulse mode (1) at time T₂.

The motor 3 rotates intermittently in the pulse mode (1) instead of continuous rotation in the drill mode and is driven in the form of a pulse, i.e., repeatedly executing “stop→forward rotational drive” a plurality of times. Now, “driven in the form of a pulse” means that the gate applied to the inverter circuit 52 is pulsated, so that the drive current for the motor 3 is pulsated, whereupon the number of rotations or the output torque of the motor 3 is pulsated. This pulsation is generated by repeatedly turning on/off the drive current in a long cycle length (for example, from several tens Hz to a hundred and several tens Hz), i.e., the drive current supplied to the motor is turned off (stop) from the time T₂ to time T₂₁, turned on (drive) from the time T₂₁ to time T₃, turned off (stop) from the time T₃ to time T₃₁, and then turned on from the time T₃₁ to time T₄. Although, during turning on the drive current, PWM control is performed in order to control the number of rotations of the motor 3, the cycle length of the pulsation is sufficiently shorter than that of the PWM (normally several kHz).

A supply of the drive current to the motor 3 is stopped from T₂ during a certain period so that the rotational speed of the motor 3 is decreased as indicated by an arrow 85b, and therefore, the hummer 41 is separated from the anvil 46. After that, the computing part 51 (FIG. 5) sends a drive signal 83a to the control signal output circuit 53 to supply a pulsed drive current (drive pulse) to the motor 3 to accelerate the motor 3. The control in this acceleration does not necessarily mean driving with a duty ratio of 100%, but can also be performed with the duty ratio less than 100%. Next, at an arrow 85c, the hammer 41 strongly collides with the anvil 46 to apply a striking force as indicated by an arrow 88a. When the striking force is applied, the supply of the drive current to the motor 3 is again stopped during a certain period so that the rotational speed of the motor 3 is decreased as indicated by an arrow 85d. After that, the computing part 51 sends a drive signal 83b to the control signal output circuit 53 to accelerate the motor 3. Then, at an arrow 85e, the hammer 41 strongly collides with the anvil 46 to apply the striking force again as indicated by an arrow 88b. In the pulse mode (1), the above-described intermittent drive “stop→forward rotational drive” of the motor 3 is repeatedly performed one or more times, but when higher tightening torque is required, the rotational drive mode is switched to the pulse mode (2). Whether the high tightening torque is necessary or not can be determined, for example, based on the number of rotations (before and after the arrow 85e) of the motor 3 when the striking force indicated by the arrow 88b is applied.

The pulse mode (2) is the rotational drive mode for driving the motor 3 intermittently in the form of a pulse similarly to the pulse mode (1), but for driving the motor 3 so as to repeat the sequence of “stop→reverse rotational drive→stop (pause)→forward rotational drive” a plurality of times. In other words, in the pulse mode (2), the reverse rotational drive in addition to the forward rotational drive for the motor 3 is also executed to rotate the hammer 41 reversely at the sufficient rotational angle relative to the anvil 46 and then to accelerate the hammer 41 in the forward rotational direction to force the hammer 41 to collide with the anvil 46 with more increased force. The hammer 41 is driven in this way to impart the strong tightening torque on the anvil 46.

In FIG. 11, the pulse mode (2) is switched at time T₄, and then the motor 3 is stopped temporarily. After that, a drive signal 84a in the negative direction is sent to the control signal output circuit 53 to rotate the motor 3 reversely. The forward and reverse rotations are performed by switching a signal pattern of the drive signal (on/off signal) outputted from the control signal output circuit 53 to each of the switching elements Q1 to Q6. After the motor 3 rotates reversely by a predetermined rotational angle, the motor 3 is stopped temporarily, and then starts to rotate in the forward direction. Specifically, a drive signal 84b in the positive direction is sent to the control signal output circuit 53. Although, the drive signal is not switched to a plus or minus side in the inverter circuit 52, the drive signal is schematically represented in the plus or minus side in order to easily understand a rotational direction of the motor 3.

When the rotational speed of the motor 3 reaches approximately a maximum speed, the hammer 41 collides with the anvil 46 (an arrow 86c). This collision generates tightening torque 89a significantly larger in comparison with the tightening torque (88a and 88b) generated in the pulse mode (1). The number of rotations of the motor 3 is decreased from an arrow 86c to an arrow 86d. Upon detecting the collision indicated by the arrow 89a, the drive signal to the motor 3 may be controlled to be stopped. In this case, if the tightening target is a bolt or a nut, a reactive force transmitted to worker's hand can be reduced. The drive current consecutively flows to the motor 3 even after the collision so that the reactive force to the worker can be decreased in comparison with the drill mode, which is suitable for work in a medium load state. Additionally, advantageous effects such as a fast tightening speed and low electric power consumption in comparison with the pulse mode (2) can be provided. After that, “stop→reverse rotational drive→stop (pause)→forward rotational drive” is repeatedly executed at predetermined times to tighten at the strong torque in the pulse mode (2). Then, the worker releases the trigger operating part 8a at time T₇ to stop the motor 3, and then the tightening is finished. The tightening operation is finished not only by releasing the trigger operating part 8a by the worker but also may be controlled so as to stop driving the motor 3 when the computing part 51 determines that the tightening target is tightened at a predetermined tightening torque on the basis of an output from the striking impact detecting sensor 56 (FIG. 5).

In the first embodiment, the impact tool 1 is driven in the drill mode in the early step of the tightening requiring small tightening torque, the tightening is performed in the pulse mode (1), which is the intermittent drive with only the forward rotation, as increasing the tightening torque, and the tightening is finally performed in the pulse mode (2) which is the intermittent drive with the forward and reverse rotations of the motor 3. In the first embodiment, the rotational drive mode may includes only the pulse modes (1) and (2) without the drill mode. Alternatively, the rotational drive mode may directly shift from the drill mode to the pulse mode (2) without the pulse mode (1). Since the motor 3 rotates alternately the forward and reverse rotations in the pulse mode (2), the tightening speed in the pulse mode (2) is significantly slower than the drill mode and the pulse mode (1). When the tightening speed suddenly slows down by switching the rotational drive mode, the worker feels unpleasant sensation in comparison with impact tools having known rotational impact mechanisms. Therefore, the pulse mode (1) preferably intervenes between the drill mode and the pulse mode (2) to provide more natural operational feeling. In addition, the tightening may be performed in the drill mode or the pulse mode (1) as long as possible, thereby minimizing the tightening work time.

Next, a procedure for controlling the impact tool 1 of the first embodiment will be described with reference to FIGS. 12 to 16. Prior to the start of work by the worker, the impact tool 1 determines whether or not to select the impact mode (S101) at the toggle switch 32 (FIG. 2). If so (S101: YES), then the routine proceeds to S102, whereas if not (S101: NO), then the routine proceeds to S110.

In the impact mode, the computing part 51 determines whether or not to turn on the trigger 8 (pulling the trigger operating part 8a) (S102). If so (S102: YES), then the motor 3 is started up in the drill mode (S103), and the computing part 51 starts the PWM control for the inverter circuit 52 in association with the stroke of the trigger operating part 8a (S104). Then, in S105, the rotation of the motor 3 is accelerated while a current value I supplied to the motor 3 is controlled so as not to exceed an upper limit value p [A] (ampere). Next, after t [ms] (millisecond) has passed from the start-up, the computing part 51 detects the current value I (S106) by an output of the current detecting circuit 59 (FIG. 5). When the current value I does not exceed p1 [A] (S107: NO), the routine returns to S104. When exceeding p1 [A] (S107: YES), the routine proceeds to S108. Next, the computing part 51 determines whether or not the current value I exceeds p2 [A] (S108).

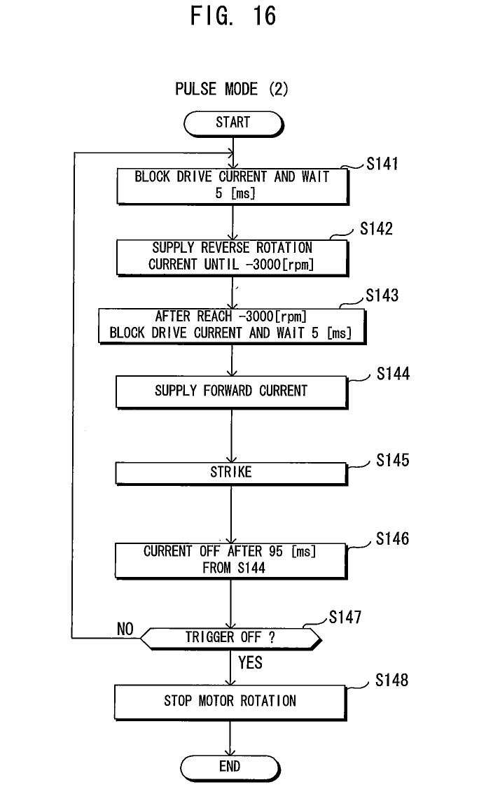

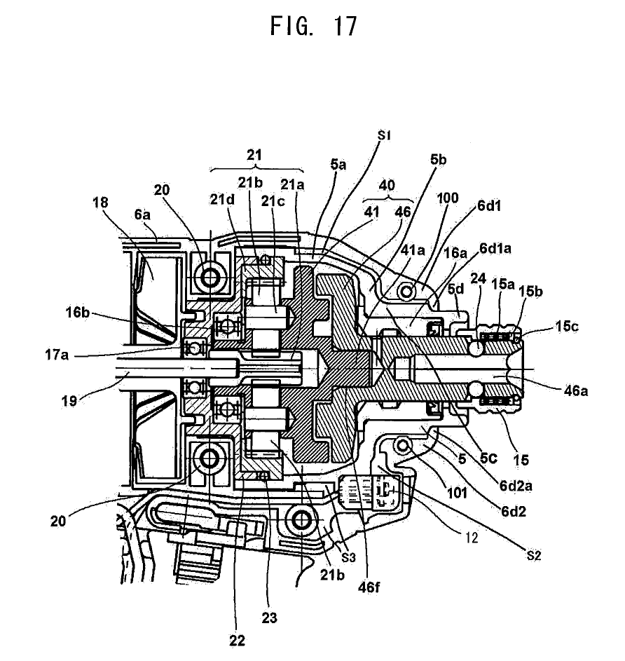

When the detected current value I does not exceed p2 [A] (S108: NO), in other words, when the relationship of p1≦I≦p2 is satisfied, the pulse mode (1) shown in FIG. 14 described later is performed (S120) and then the routine proceeds to S109. When the current value I exceeds p2 [A] (S108: YES), the routine directly proceeds to S109 without performing the pulse mode (1). In S109, the computing part 51 determines whether or not the trigger 8 is turned on. If not (S109: NO), the routine returns to S101. When the trigger 8 is kept being turning on (S109: YES), the pulse mode (2) shown in FIG. 16 described later is performed (S140), and then the routine returns to S101.

When the drill mode is selected in the S101 (S101: NO), the drill mode is performed, but is controlled similarly to S102 to S107. Then, a control current in the electronic clutch mechanism or an overcurrent before locking the motor 3 is detected as p1 [A] in the S107 to stop the motor 3 (S111). Then, the drill mode is finished to return to S101.

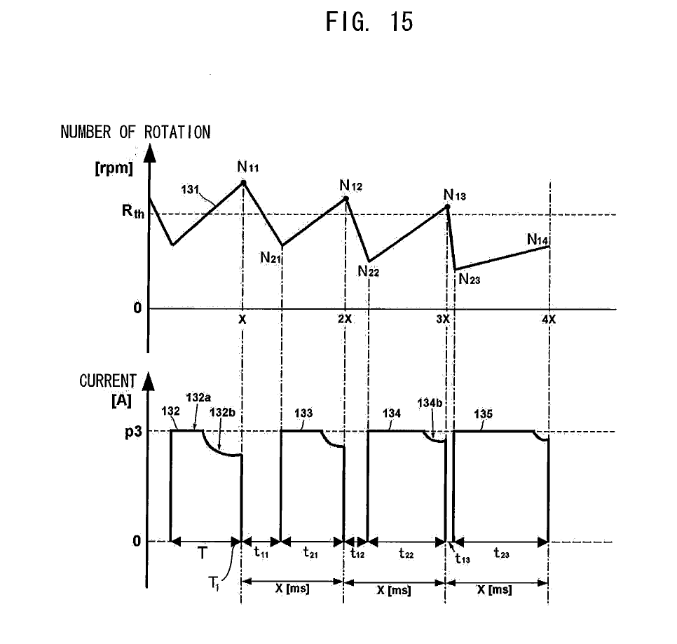

Now, a determining procedure in S107 and S108 will be described with reference to FIG. 13. Graphs at the upper side illustrate the relationship between elapsed time and the number of rotations of the motor 3. Graphs at the lower side illustrate the relationship between elapsed time and a current value supplied to the motor 3. The graphs at the upper and lower sides have the same time axis. In the left graph, the trigger 8 is pulled at time T_{A} (corresponding to S102: YES in FIG. 12), and then the motor 3 is started up and accelerated as indicated by an arrow 113a. In this acceleration, the current value is constantly controlled so as not to exceed the upper limit value p [A] as indicated by an arrow 114a (S105 in FIG. 12). When the number of rotations of the motor 3 reaches the predetermined number of rotations (arrow 113b), the current value is gradually decreased due to a change from an acceleration state current to a steady state current as indicated by an arrow 114b. After that, as the tightening target (a screw, a bolt, or the like) is tightened, the reactive force from the tightened target increases. Then, a current value supplied to the motor 3 increases while the number of rotations of the motor 3 gradually decreases as indicated by an arrow 113c. The current value is determined after t [ms] has passed from starting up timing of the motor 3 (S106 in FIG. 12). When the relationship of p1≦I≦p2 as indicated by an arrow 114c is satisfied (S108: NO), the procedure transitions to the pulse mode (1) described later (S120 in FIG. 12).

In the right graph, the trigger 8 is pulled at time T_{B} (corresponding to the S102: YES in FIG. 12), and then the motor 3 is started up and accelerated as indicated by an arrow 115a. In this acceleration, the current value is constantly controlled so as not to exceed the upper limit value p [A] as indicated by an arrow 116a (S105 in FIG. 12). When the number of rotations of the motor 3 reaches the predetermined number of rotations (arrow 115b), the current value is gradually decreased due to a change from the acceleration state current to the steady state current as indicated by an arrow 116b.

After that, as the tightening target (a screw, a bolt, or the like) is tightened, the reactive force from the tightened target increases. Then, the current value supplied to the motor 3 increases while the number of rotations of the motor 3 decreases gradually as indicated by an arrow 115c. Since the reactive force from the tightened target increases sharply, the number of rotations of the motor 3 decreases significantly as indicated by an arrow 115c, and therefore the current value increases to a high degree. After t [ms] has passed from the starting up timing of the motor 3, the current value satisfies the relationship of p2≦I as indicated by 116c (S108: YES). Therefore, the procedure transitions to the pulse mode (2) shown in FIG. 16.

The necessary tightening torque is often not constant in tightening a screw, a bolt, or the like, due to the variation in machining accuracy of the screw or the bolt, a state of the workpiece, or the variation in material such as wood grain and a knag of wood. The tightening may be performed in the drill mode until immediately before completing the tightening. In such a case, the tightening in the pulse mode (1) is skipped and the pulse mode (2) whose tightening torque is higher than that in the pulse mode (1) is performed, which can complete the tightening work efficiently in a short time.

Next, a procedure for controlling the impact tool 1 in the pulse mode (1) will be described with reference to FIG. 14. Upon transitioning to the pulse mode (1), the upper limit value is controlled to be less than or equal to p3 [A] (S121), and a forward rotation current is supplied to the motor 3 during a predetermined period, for example, T [ms] (S122). Next, the computing part 51 detects the number of rotations N₁ₙ (where n=1, 2, . . . )[rpm] of the motor 3 after T [ms] has passed (S123).

Next, the computing part 51 blocks the drive current supplied to the motor 3 (S124) until the number of rotations of motor 3 falls to N₂ₙ, and measures time t₁ₙ for which the number of rotations of the motor 3 falls from N₁ₙ to N₂ₙ (=N₁ₙ/2) (S125). Next, time t₂ₙ is obtained from formula t₂ₙ=X−t₁ₙ, and the forward rotation current is supplied to the motor 3 during period of time t₂ₙ (S126) while the upper limit value is controlled to be less than or equal to p3 [A] (S127). The computing part 51 determines, after time t₂ₙ has passed, whether or not the number of rotations N₁₍ₙ₊₁₎ of the motor 3 is less than or equal to a threshold value Rₜₕ (S128). If so (S128: YES), then the routine is finished and returns to S120 in FIG. 12. If not (S128: NO), then the routine returns to S124.

As shown in FIG. 15, the drive current is controlled to be less than or equal to p3 [A] (S121 in FIG. 14). The drive current 132 is supplied to the motor 3 during time T (S122 in FIG. 14). Therefore, a current value in the acceleration state is limited as indicated by an arrow 132a, and then a current value decreases as indicated by an arrow 132b as the number of rotations of the motor 3 increases. When the computing part 51 measures that the number of rotations of the motor 3 reaches N₁₁ [rpm] at time T₁ (S123 in FIG. 14), the computing part 51 calculates the number of rotations N₂₁ at which the motor 3 starts rotating by formula N₂₁=N₁₁/2. The number of rotations N₁₁ is, for example, 10,000 rpm. When the number of rotations of the motor 3 decreases to N₂₁ (S124 in FIG. 14), a drive current 133 is supplied to accelerate the motor 3 again (S126 in FIG. 14). Time t₂ₙ for supplying the drive current 133 is determined by formula t₂ₙ=X−t₁ₙ.

Similar control is repeatedly performed at time 2X and 3X. However, as the reactive force from the tightening target increases, a degree of an increase in number of rotations of the motor 3 is lowered, and then the number of rotations N₁₄ is less than or equal to the threshold value Rₜₕ at time 4X (S128: YES). At this time, the process for the pulse mode (1) is finished and the procedure transitions to the pulse mode (2).

Next, a procedure for controlling the impact tool 1 in the pulse mode (2) will be described with reference to FIG. 16. First, the computing part 51 blocks the drive current to the motor 3 and waits for 5 [ms] (S141). Next, a reverse rotation current is supplied to the motor 3 to reversely rotate the motor 3 at −3000 [rpm] (S142). Now, the “−3000 rpm” means a rotation at 3000 rpm in the direction opposite to the forward rotational direction for tightening. Next, when the number of rotations of the motor 3 reaches −3000 [rpm], the computing part 51 blocks the drive current supplied to the motor 3 and waits for 5 [ms] (S143). If the motor 3 is immediately rotated in the reverse direction without waiting for 5 [ms], the impact tool 1 may be shaking or swung. Energy saving can be achieved due to no electric power consumption in this waiting state. Therefore, the computing part 51 waits for 5 [ms].

Next, the forward rotation current is supplied (S144) in order to rotate the motor 3 in the forward rotational direction. The computing part 51 blocks the drive current supplied to the motor 3 for 95 [ms] after the forward rotation current is supplied (S146). Before this current blocking, the hammer 41 collides with (strikes) the anvil 46 to impart strong tightening torque on the end tool (S145). After that, the computing part 51 detects whether or not the trigger 8 is kept being turning on (S147). If so (S147: YES), the rotation of the motor 3 is stopped to finish the process for the pulse mode (2) (S148) and the routine returns to S140 in FIG. 12. If not (S147: NO), the routine returns to S141.

As described above, in the first embodiment, the hammer 41 and the anvil 46 having their relative rotational angle less than one rotation are used to rotate the motor continuously, intermittently in only the forward direction, and intermittently in the forward and reverse directions, thereby tightening the tightened target efficiently. Additionally, the hammer 41 and the anvil 46 can have simplified configurations, and therefore, resultant impact tool can have a compact size and can be produced at a low cost.

The present invention has been described above based on the first embodiment. However, the present invention is not limited to this configuration, and can be variously changed without departing from the scope of the present invention. Although the brushless DC motor is employed as the motor 3 in the first embodiment, other types of motors capable of being forwardly/reversely rotating may be employed.

Further, the anvil 46 and the hammer 41 can be changed to any shapes as long as the anvil and the hammer cannot be continuously rotated relatively (cannot be rotated while moving past each other), and ensure the predetermined relative rotational angle less than 360 degrees, and have the striking surface and the struck surface. For example, the projecting parts of the hammer and the anvil may project in the circumferential direction instead of the axial direction. Furthermore, the projecting parts of the hammer and the anvil are not limited to the configuration in which the projecting part is convex outwardly. The striking surface and the struck surface may be formed in any shape, for example, the projecting part may project to an inside of the hammer or the anvil (in other words, a concave part). Additionally, the striking surface and the struck surface are not limited to a plane and may have other shapes, for example curved surface, so as to properly strike and to be struck.

An impact tool according to a second embodiment of the present invention will be described with reference to FIG. 17. The description below deals only with a part and component different from those of the first embodiment, and like part and components are designated by the same reference numerals as those shown in the first embodiment.

As shown in FIG. 17, the hammer case 5 has a large-diameter part 5a at a rear portion thereof, a step part 5b provided with a tapered step at the front side of the large-diameter part 5a, a small-diameter part 5c whose diameter is smaller than that of the large-diameter part 5a and located at the front side of the step part 5b, and a front end part 5d at the front side of the small-diameter part 5c.

The trunk part 6a has a front portion provided with a front part 6d (including a front upper part 6d1 and a front lower part 6d2) which integrally extends frontward. In this way, the trunk part 6a covers the hammer case 5 such that only the front end part 5d is exposed outside of the trunk part 6a of the housing 6.

A gap S1 is formed between the inner circumference surface of the front upper part 6d1 and the outer circumference surface of both the step part 5b and the small-diameter part 5c. A gap S2 is formed between the inner circumference surface of the front lower part 6d2 and the outer circumference surface of both the step part 5b and the small-diameter part 5c. A gap S3 is formed between the inner circumference surface of the front lower part 6d2 and the outer circumference surface of the large-diameter part 5a. The gap S2 spatially communicates with outside of the housing 6 through a hole formed in the front parts 6d at the front of the LED light 12.

Since the gaps S1, S2, and S3 are formed between the inner circumference surface of the front part 6d and the outer circumference surface of the hammer case 5, heat caused by striking the hammer 41 with the anvil 46 is transferred from the hammer case 5 to the front part through air in the gaps S1-S3, which does not directly transfer the heat to the front parts 6d, thereby reducing a thermal deformation of the front parts 6d.

The housing 6 is divided into two right and left members having substantially symmetrical shapes. The same is true with respect to the front parts 6d. These right and left front parts 6d are fixed with each other by two screws inserted into screw bosses 100 and 101. The screw boss 100 is located at the front upper part 6d1 immediately above the small-diameter part 5c and the screw boss 101 is located at the front lower part 6d2 immediately below the small-diameter part 5c.

Additionally, a front upper end part 6d1a is provided at the front end of the front upper part 6d1. The front upper end part 6d1a extends inwardly in the radial direction, and is in contact with the small-diameter part 5c. A front lower end part 6d2a is provided at the front end of the front lower part 6d2. The front lower end part 6d2a extends inwardly in the radial direction, and is in contact with the small-diameter part 5c. Specifically, the front upper end part 6d1a and the front lower end part 6d2a are entirely in contact with the small-diameter part 5c in the circumferential direction. Thus, the front upper end part 6d1a and the front lower end part 6d2a support the small-diameter part 5c to restrain movement of the hummer case 5 in the radial direction.

As described above, the screw bosses 20 are located radially outwardly above and below the rear portion of the inner cover 22. With this arrangement, the screw (fixing member) can fix the hammer case 5 to the housing 6 through the screw boss 20 and the inner cover 22.

Specifically, the inner circumference surface of the trunk part 6a tightened through the screw bosses 20 is in contact with the outer circumference surface of the inner cover 22 so that the hammer case 5 can be stably fixed to the housing 6.

As described above, the front portion of the hammer case 5 is supported through the screw boss 100 by the front upper end part 6d1a and the front lower end part 6d2a, and the rear portion of the hammer case 5 is supported by the screw boss 20. In the first embodiment, the hummer case 5 is supported by the housing 6 and the cover 11 which is an alternative member of the housing 6 so that the hummer case 5 is subject to move with respect to the cover 11 and the housing 6. On the other hand, in the second embodiment, the hummer case 5 is fixedly supported by only the housing 6 (trunk part 6a). With this configuration, misalignment of the hammer case 5 with respect to the trunk part 6a can be reduced.

Additionally, since the trunk part 6a covers the hammer case 5 such that only the front end part 5d of the hammer case 5 is exposed outside of the trunk part 6a, parts other than the front end of the hammer case 5 do not damage the workpiece such as wood.

As described in the second embodiment, the advantageous effects of the present invention can be applied to an ordinary available impact tool in which a hammer rotated by a motor strikes an anvil in the rotational direction.

### REFERENCE SIGNS LIST

1 impact tool
3 motor
3a rotor
3b stator
3c permanent magnet
3d insulator
3e coil
5 hammer case
5a large-diameter part
5b step part
5c small-diameter part
5d front end part
6 housing
6a trunk part
6b grip part
6c battery holder
6d front part
6d1 front upper part
6d1a front upper end part
6d2 front lower part
6d2a front lower end part
7 substrate
8 trigger
8a trigger operating part
9 control circuit substrate
10 switching element
Q1-Q6 switching element
12 LED light
14 switching lever
15 sleeve
16a metal bearing
16b bearing
17a bearing
17b bearing
18 cooling fan
18a penetrating hole
18b cylindrical part
18c fin
18d opening
19 rotation shaft
20 screw boss
21 planetary gear deceleration mechanism
21a sun gear
21b planetary gears
21c rotation shaft
21d outer gear
22 inner cover
23 O-ring
26a, 26b air inlet
26c slit
30 battery pack
30a release buttons
31 control panel
32 toggle switch
33 metal belt hook
34 strap
40 impact mechanism
41 hammer
41a fitting shaft
41b columnar main body
41c wing part
41d wing part
42, 43 projecting part
43a, 43b striking surface
42a, 42b striking surface
44a, 44b disk part
44d penetrating hole
44c connection part
44e cylindrical part
44f space
46 anvil
46c, 46d wing part
46f fitting hole
47 projecting part
47a, 47b struck surface
48 projecting part
48a, 48b struck surface
50 controller
51 computing part
52 inverter circuit
53 control signal output circuit
54 rotor position detecting circuit
56 striking impact detecting sensor
57 striking impact detecting circuit
58 detecting element
59A current detecting circuit
61 voltage setting circuit
62 rotational direction setting circuit
100, 101 screw boss
151 hammer
151a fitting shaft
151b main body
151c disc part
151d connection part
151f penetrating hole
152, 153 projection part
152a, 152b striking surface
156 anvil
156a mounting hole
156b main body
157, 158 projecting part
157a, 157b struck surface

1. An impact tool comprising:
a motor;
a housing accommodating therein the motor;
a hummer rotatable by the motor;
an anvil against which the hummer strikes in a rotational direction of the hummer;
a hummer case covering the hummer and the anvil; and,
an end tool holding unit connected to the anvil and protruding from the hummer case in a first direction,
wherein the housing supports the hummer case at at least two locations.

2. The impact tool according to claim 1, wherein the housing comprises a first housing part and a complementary second housing part; and,
the impact tool further comprising fixing members that fixes the first housing part and the second housing part to each other at a front side and a rear side of the hammer case in the first direction to fixedly support the hammer case by the first housing part and the second housing part.

3. The impact tool according to claim 2, further comprising a restricting member provided at a front end portion of the housing to restrict movement of the hummer case in a radial direction of the hummer.

4. The impact tool according to claim 1, wherein a gap is formed between an inner surface of the housing and an outer surface of the hummer case.

5. The impact tool according to claim 4, wherein the gap is spatially in communication with an outside of the housing.

6. The impact tool according to claim 1, wherein the housing covers the hummer case such that a front end portion of the hummer case is exposed to an outside of the housing.

7. The impact tool according to claim 1, wherein the housing comprises a first housing part and a complementary second housing part,
the impact tool further comprising fixing members that fixes the first housing part and the second housing part to each other at a front side of the hammer case and at a position above and below the hammer case to fixedly support the hammer case by the first housing part and the second housing part.

8. The impact tool according to claim 7, wherein a gap is formed between an inner surface of the housing and an outer surface of the hummer case.

9. The impact tool according to claim 8, wherein the gap is spatially in communication with an outside of the housing.

10. The impact tool according to claim 7, wherein the housing covers the hummer case such that a front end portion of the hummer case is exposed to an outside of the housing.

11. An impact tool comprising:
a motor;
a housing accommodating therein the motor;
a hummer rotatable by the motor;
an anvil against which the hummer strikes in a rotational direction of the hummer;
a hummer case covering the hummer and the anvil, the hammer case having a front end portion; and
an end tool holding unit connected to the anvil and protruding from the hummer case;
wherein the housing substantially covers an entirety of the hummer case including almost a major portion of the front end portion.

12. The impact tool according to claim 11, wherein a gap is formed between an inner surface of the housing and an outer surface of the hummer case.

13. The impact tool according to claim 12, wherein the gap is spatially in communication with an outside of the housing.

14. The impact tool according to claim 11, wherein the housing covers the hummer case such that the front end portion of the hummer case is exposed to an outside of the housing.
